(19) United States
(12) Patent Application Publication
(10) Pub. No.: US 2006/0117720 A1
(43) Pub. Date: Jun. 8, 2006

(54) Treeless exercise saddle and method of making the same

(76) Inventor: Peter A. DeCosemo, Vancouver, WA (US)

Correspondence Address: Ingrid McTaggart, 1816 S.E. 54th Ave., Portland, OR, 97215, US

(21) Appl. No.: 11/336,752

(22) Filed: Jan. 20, 2006

Related U.S. Application Data
(63) Continuation-in-part of application No. 10/968,670, filed on Oct. 18, 2004.

(51) Int. Cl. B68C 1/02

(52) U.S. Cl. 54/44.1

(57) ABSTRACT

One embodiment of a flexible, treeless saddle includes a non-rigid saddle body including a top surface, and a stirrup hanger cover secured to the top surface and positioned only in a pommel region of the body.

This application is a Continuation-in-Part of U.S. patent application Ser. No. 10/968,670, filed on Oct. 18, 2004, in the name of Peter DeCosemo and entitled TREELESS RIDING SADDLE AND METHOD OF MAKING THE SAME.

### TECHNICAL FIELD

The present invention relates to a treeless exercise saddle and a method of making the same, and more particularly, to a treeless exercise saddle that provides a fully flexible saddle which conforms to and continuously contacts a horse's back during all types of movement, while simultaneously providing contoured support for an exercise rider which enables the rider to fully communicate with the horse.

### BACKGROUND OF THE INVENTION

Throughout history saddles have facilitated riders in remaining mounted on their horse. Early saddles comprised a simple, flat saddle blanket secured to the back of a horse. This simple design facilitated the rider remaining on the horse during calm movements, such as walking, but did not help the rider to remain on the horse during faster movements such as galloping or jumping. With the arrival of organized warfare a more substantial saddle was developed which included a rigid saddletree that anchored a soldier in the saddle and rendered him difficult to dislodge by his opponents.

These rigid saddletrees were thought to distribute the weight of the rider evenly over the horse's back by providing a rigid frame. This rigid frame design was thought to ease the workload of the horse and evenly distribute the weight of the rider. Rigid saddletrees were also thought to provide the rider with a stable support base from which to control the horse by providing a permanent arched shape to the saddle including a raised pommel, a raised cantle and a lowered seat area positioned therebetween. Due to these perceived benefits, rigid saddletrees have become standard in virtually all saddle designs.

In the environment of exercise or racing of a horse, the rider or jockey attempts to push the horse to its fastest speed. Rigid saddletrees may inhibit the horse from exercising or racing at its fastest speed because the rigid saddletree may be jammed into the horses back or shoulders, inhibiting movement of the horses shoulders. Accordingly, rigid saddletrees may decrease the performance of the horse and rider, cause pain to both horse and rider, cause behavioral problems by the horse, and in some cases, cause injury to the horse and rider.

### SUMMARY OF THE INVENTION

One embodiment of a flexible, treeless saddle includes a non-rigid saddle body including a top surface, and a stirrup hanger cover secured to the top surface and positioned only in a pommel region of the body.

### BRIEF DESCRIPTION OF THE DRAWINGS

FIG. 1 is a perspective view of a prior art rigid saddletree;

FIG. 2 is a perspective view of one embodiment of the treeless exercise saddle of the present invention;

FIG. 3 is a bottom view of a right half section of the saddle body;

FIG. 4 is a bottom view of a right half section of body foam;

FIG. 5 is a top view of a billet assembly;

FIG. 6 is a top view of a pommel reinforcement piece;

FIG. 7 is a bottom view of a saddle body including the billet assembly and the pommel reinforcement piece secured thereto;

FIG. 8 is a bottom view of the saddle body including a gullet cover secured thereto;

FIG. 9 is a top view of a stirrup hanger assembly;

FIG. 10 is a top view of the saddle body including the stirrup hanger assembly secured thereto;

FIG. 11 is a perspective view of a pommel foam;

FIG. 12 is a top view of the saddle body including the pommel foam and a seat foam secured thereto;

FIG. 13 is a top view of a body cover;

FIG. 14 is a bottom view of a pommel cover;

FIG. 15 is a top view of the pommel cover secured to the body cover;

FIG. 16 is a top view of the saddle body including the body cover secured thereto;

FIG. 17 is a top view of a back pad;

FIG. 18 is a side view of the back pad;

FIG. 19 is a top view of a back pad foam; and

FIG. 20 is a bottom view of the saddle body including the body cover secured to the saddle body in an edge region thereof.

### DETAILED DESCRIPTION

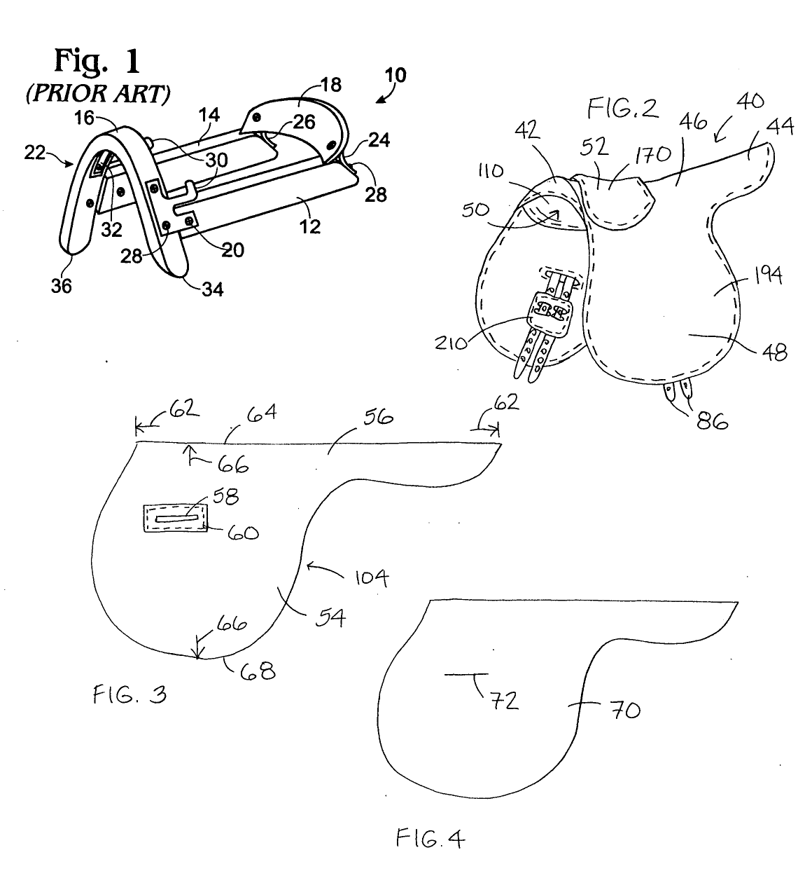

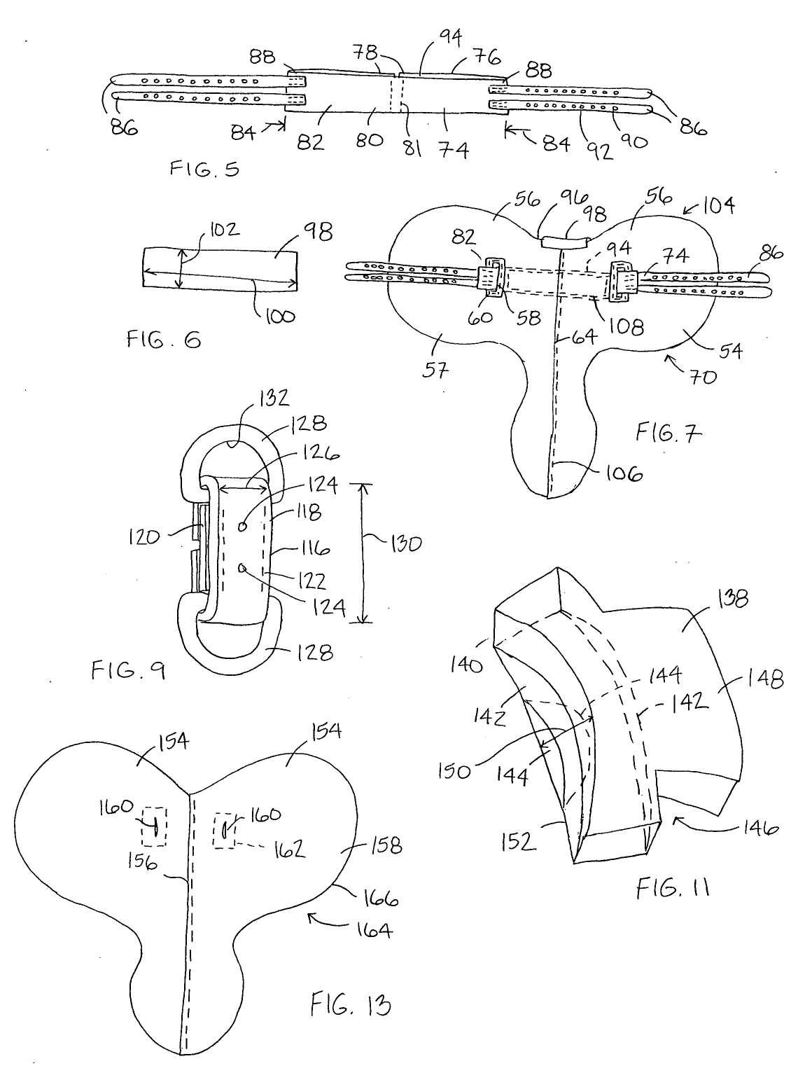

Referring to FIG. 1, a prior art rigid saddletree 10, also called a tree or a frame, typically is positioned within the outer covering of a prior art saddle (not shown). Rigid saddletree 10 comprises two side bars 12 and 14, an arched front section, also called a pommel 16, and a contoured rear seat, also called a cantle 18. Side bars 12 and 14, pommel 16, and cantle 18 are manufactured of rigid material, typically wood or metal. In the prior art embodiment shown, the frame is manufactured of wood wherein steel braces 20, 22, 24 and 26 are fastened to the individual wooden pieces by fasteners 28 to rigidly secure the frame together. Front steel braces 20 and 22 also include rearward extending hooks 30 for the attachment of stirrups thereto (not shown) for support of the rider's feet. Pommel 16 may also include a steel support brace 32 to ensure the wooden arch holds its shape during use. Pommel 16 further includes two lower “points” 34 and 36.

In use, side bars 12 and 14 are placed along the back of the horse straddling the spine, wherein the weight of the rider forces the bars downwardly into the horse's back and shoulders. This may inhibit the horse's performance and/or lead to injury of the horse's back or shoulders. The frame provides a rigid support base for the rider which isolates the rider from fully sensing the movements of the horse. Moreover, the rigid frame hinders the horse from sensing subtle movements of the rider. Accordingly, in general, the rigid frame inhibits communication between horse and rider.

When the rigid saddletree of the prior art is secured to a horse, the pommel part of the rigid tree is placed over or just rearwardly of, but still in contact with, the back edge of the horse's shoulder blade, also called a scapula, when the horse is in the standing position. The rigid saddletrees of the prior art cannot be placed more rearwardly on a horse because the horse's back becomes too flat so that side bars 12 and 14 would not contact the sides of the horse but instead would stand up on the horse's back.

Upon movement of the horse, the front legs of the horse move forwardly which rotates the scapula rearwardly and into or under the rigid saddletree. This contact of the horse's scapula with the rigid saddletree can be quite painful. When the horse gallops or canters, the hind end of the horse thrusts upward and forward, thereby thrusting the rigid saddletree and the rider forward. This movement further forces the rigid frame into the horse's shoulders. Moreover, the movement is exaggerated during rigorous riding when the horse may start or stop abruptly. In particular, lower pointed ends 34 and 36 of the pommel region dig into the horse's shoulders with each stride. When a rider places his weight on the stirrups, instead of on the saddle seat, the forward position of the stirrup hooks 30 causes rear cantle 18 to rise up above the horse's back, and causes front pommel 16, and points 34 and 36, to further dig down into the horse's shoulders. The rigid frame construction of the prior art does not allow one to position the saddle rearwardly of the horse's shoulder blades because the scapula acts as a brake on this forward movement of the saddle when weight is placed on the stirrups or when the horse runs. For all these reasons, rigid saddle trees may not facilitate the best performance of the horse and/or rider.

FIG. 2 shows one embodiment of a completed flexible treeless exercise saddle 40 of the present invention including an upwardly extending, riding style pommel 42, a flat cantle region 44, and a flat seat region 46, lowered with respect to pommel 42, the seat region 46 being positioned between pommel 42 and cantle region 44. The saddle further comprises a leg region 48, a gullet 50 positioned on an underside of the saddle, and a stirrup hanger cover 52. The method of making the saddle of the present invention will be shown in a step by step fashion.

FIG. 3 shows an underside 54 of one half section 56 of two mirror image body half sections which are each cut from heavy pebble leather. The half section 56 shown is a right side piece, meaning that when the completed saddle is viewed from the top, with the pommel of the saddle positioned forwardly from the cantle, half section 56 will be positioned on the right side of the saddle. As will be understood by those skilled in the art, the saddle of the present invention can be manufactured of any flexible material such as leather, flexible plastic, material, or the like, in any desired weight, strength, color or thickness. The saddle may also be manufactured in any size as is desired for a particular application. Accordingly, Applicant describes herein one method of making the inventive saddle according to one embodiment but is not limited to this particular embodiment. Moreover, many of the steps of the method of the present invention involve mirror image steps wherein only one of the mirror image steps is described for the sake of brevity.

Half section 56 is cut to define an aperture, also called a billet hole 58. Billet hole 58 may be approximately two inches long and one eighth of an inch high. The billet hole 58 is reinforced by sewing a billet hole reinforcing patch 60 around hole 58. Patch 60 may be a piece of leather approximately 3½ inches long and 1½ inches high, and including a hole that matches the size of billet hole 58. Patch 60 may also be glued to half section 56 before being sewn thereto. When gluing components of the saddle, typically, quick drying all purpose rubber cement is used, though other adhesives may also be used. The half sections 56 typically have a width 62 measured along upper edge 64, of approximately eighteen inches, and a length 66 measured from upper edge 64 downwardly to a lower edge 68, of approximately fifteen inches.

After reinforcing billet hole 58, left and a right half body sections 56 are sewn together along upper edge 64 to define a saddle body 57 (see FIG. 7). The half sections 56 may be sewn together on a sewing machine due to use of soft pebble leather for half sections 56.

FIG. 4 shows a piece of body foam 70 cut to match the size of a body section 56 (see FIG. 3). Foam 70, in the embodiment shown, is a grey, one quarter inch thick multipurpose low-density continuous rolled foam (hereinafter referred to as “MLC foam”). Foam 70 is cut with a slit or hole 72 that approximately matches the size and placement of billet hole 58 cut in body half section 56 (see FIG. 3). A piece of body foam 70 is then glued to the topside 104 (see FIG. 3) of each of leather body half sections 56.

FIG. 5 is a top view of a billet assembly 74. In the embodiment shown, assembly 74 includes a thirty inch length of two inch wide seat belt webbing 76 doubled over on itself. The ends 78 of the webbing are sewn to a central region 80 of the webbing by stitching 81 to define a double strength webbing 82 having a length 84 of approximately fifteen inches. Two billet straps 86 are sewn to each edge region 88 of webbing 82. Each billet strap 86 is cut from skirt hide leather, number one grade, twelve to thirteen ounce weight, in one inch wide, sixteen inch long strips. Ten billet strap holes 90 are cut in each strap 86 and the edge 92 of each strap is rounded for ease of use. Holes 90 may be cut, and edges 92 may be rounded on straps 86 prior to sewing the straps to double strength webbing 82.

Billet assembly 74 is then glued and sewn to saddle body 57 (see FIG. 7), with a front edge 94 of double strength webbing 82 positioned approximately two and a half inches rearwardly from a front edge 96 (FIG. 7) of body 57.

FIG. 6 shows a pommel reinforcement piece 98. Reinforcement piece 98 is cut from nine pound latigo leather, having a length 100 of approximately four inches and width 102 of approximately one and a quarter inches. Reinforcement piece 98 is glued into place on front edge 96 of saddle body 57 such that half of piece 98 is positioned on underside 54 (see FIG. 7) of saddle body 57 and another half of piece 98 is positioned on a topside 104 of saddle body 57 (see FIG. 7).

FIG. 7 shows underside 54 of saddle body 57 including two half sections 56 sewn together with stitching 106 along upper edges 64 thereof, body foam 70 glued to topside 104 of each of half sections 56, billet assembly 74 secured to topside 104 of saddle body 57, with straps 86 of billet assembly 74 extending through billet holes 58 to underside 54, and pommel reinforcing piece 96 secured to front edge 94 of body 57. Billet assembly 74 is show sewn to body 57 by stitching 108.

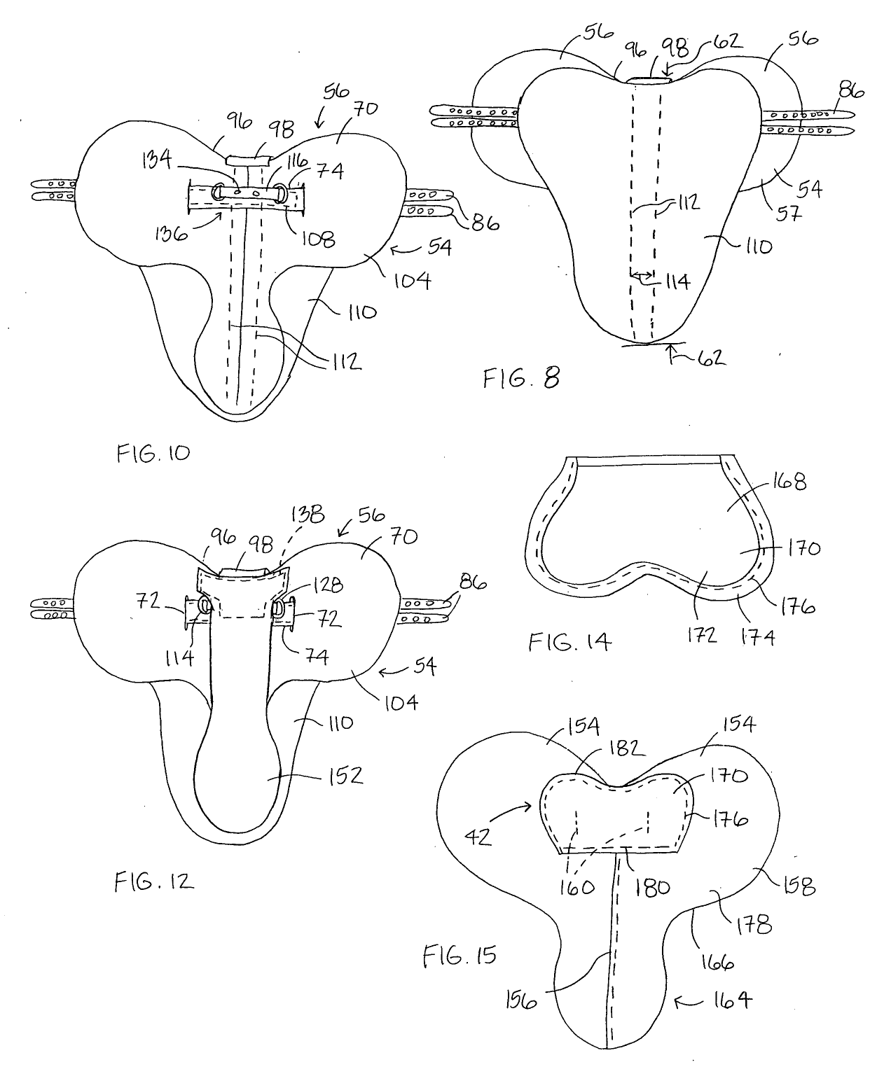

FIG. 8 shows a gullet cover 110 sewn to underside 54 of saddle body 57 by stitching 112 in two lines along length 62 of body 57, the two lines of stitching 112 spaced approximately two inches apart across a gullet width 114. The ends of the two lines of stitching 112 (in the pommel and cantle regions) may not be closed with stitching at this time but may be closed by stitching 208 (see FIG. 20) near the end of the manufacturing process. Prior to sewing cover 110 to body 57, body 57 may be marked along the stitch lines to ensure that cover 110 is sewn to body 57 at a proper position. Gullet cover 110 may be cut from soft pebble leather.

FIG. 9 shows a stirrup hanger assembly 116, made from a long leather strap 118 and a short leather strap 120 stitched together by stitching 122 and including rivet apertures 124. Each of straps 118 and 120 has a width 126 of approximately one and a quarter (1.25) inches. The long leather strap captures two D-ring stirrup hangers 128, which typically are manufactured of a pre-cast, durable and strong material such as metal. Each of the rings 128 measures approximately one (1) inch by one (1) inch and stirrup hanger 116 typically has a length 130 of the leather components of approximately four (4) inches. Each of rings 128 includes a central aperture 132 for receiving a stirrup strap as will be understood by those skilled in the art. D-rings 128 may be utilized instead of “breakaway” type stirrup bars because during exercise of racing horses, the rider or jockey may be positioned upwardly and forwardly on the exercise saddle with their feet in the stirrups positioned rearwardly of the rider. In such a position, “breakaway” type stirrup hangers may not function to retain the stirrups (not shown) on stirrup hanger assembly 116.

FIG. 10 shows stirrup hanger 116 secured to saddle body 57 by rivets 134 positioned through rivet holes 124 in the stirrup hangers and through rivet holes 136 punched through saddle body 57 and through gullet cover 110. Rivets 134 typically comprise one (1) inch polished copper rivets which are riveted upwardly from the underside 54 of the saddle body through to the topside 104 of the saddle body 57.

FIG. 11 is a perspective side view of a pommel foam 138. Pommel foam 138 typically includes a first piece 140 of one half inch thick MLC foam, glued to a second piece 142 of one half inch MLC foam, glued to a third piece 144 of white, half inch thick cross-linked polyethylene (XPE) foam. First piece 140 is tee-shirt shaped, second piece 142 is a strip and third piece 144 is approximately half moon shaped. When glued together, the three foam pieces define a smooth upwardly extending pommel foam 138 having a recessed region 146 positioned underneath a rearward region 148 of first foam piece 140. Recessed region 146 is sized to be positioned over stirrup hanger assembly 116 (see FIG. 10) when pommel foam 138 is secured to the saddle body. Pommel foam 138 typically defines a height 150 of approximately one and a half inches.

After formation thereof, pommel foam 138 is glued to topside 104 of saddle body 57 (see FIG. 12), on top of body foam pieces 70 and on top of stirrup hanger assembly 116, such that a front edge 152 of pommel foam 138 is positioned on front edge 96 (see FIG. 12) of saddle body 57 and such that stirrup hanger assembly 116 (see FIG. 12) is positioned within recess 146.

FIG. 12 shows a seat foam 152 glued to topside 104 of saddle body 57, and on top of pommel foam 138, stirrup hanger assembly 116 and body foam pieces 70. The D-rings 128 of stirrup hanger assembly 116, and a portion of billet assembly 74 may protrude out from under seat foam 152. Seat foam 152 may be made of half inch thick MLC foam.

FIG. 13 shows two body cover pieces 154, cut from soft pebble leather. Body cover pieces 154 are sewn together along their top edge 156 to form a body cover 158. Stirrup hanger slits 160 are then cut in body cover 158 in a position such that D-rings 128 will protrude through stirrup hanger slits 160 when body cover 158 is secured to topside 104 of saddle body 57 (see FIG. 12). Stirrup hanger slits 160 may be reinforced by stirrup hanger slit patches 162 sewn and glued to an underside 164 of body cover 158. Patches 162 may each be a piece of heavy pebble leather approximately three and a half inches long and one and a half inches high, and including a hole that matches the size of stirrup hanger slits 160. Each of body cover pieces 154 is typically larger in size than each of body half sections 56 (see FIG. 3) so that body cover 158 can be secured to saddle body 57 (see FIG. 20) by wrapping an edge 166 of body cover 158 around an edge of half sections 56 to underside 54 of saddle body 57 (see FIG. 12), and then sewing around edge 166. Body cover pieces 154 may be cut from soft pebble leather.

FIG. 14 shows an underside 168 of a stirrup hanger cover 170. Hanger cover 170 may be formed of a lower piece 172 of latigo leather having an upper piece 174 of soft pebble leather wrapped around a portion of an edge of lower piece 172 and glued and sewn thereto by stitching 176.

FIG. 15 shows hanger cover 170 secured to a topside 178 of body cover 158 by stitching 180 positioned approximately two and three quarters inches rearwardly of stirrup hanger slits 160 (shown positioned beneath cover 170 as dash lines). As shown in the figure, hanger cover 170 is positioned only in the pommel region 42 of the saddle. The remainder of hanger cover 170 is not sewn to topside 178. Therefore, the forward edge 182 of hanger cover 170 is unsecured and may open in a flap-like manner on body cover 158 to allow access to stirrup D-rings 128 (see FIG. 16), as will be discussed below.

FIG. 16 shows body cover 158 glued to saddle body 57 (shown in dash lines) including body foam pieces 70 (shown in dash lines) and seat foam 152 (shown in dash lines). After gluing body cover 158 to saddle body 57, hanger cover 170 is pulled rearwardly to access slits 160. D-rings 128 of stirrup hanger assembly 116 are then pulled through slits 160. The saddle is then sewn in the region of stirrup hanger assembly 116 by stitching 184 to further secure body cover 158 to saddle body 57 and to compress seat foam 152 and body foam pieces 70 in the region underneath and around D-rings 128. By compressing the foam in the region directly adjacent to and underneath of D-rings 128, the D-rings will be recessed slightly with respect to a remainder of seat foam 152 so as to provide a relatively flat and comfortable seat region 18 for a rider.

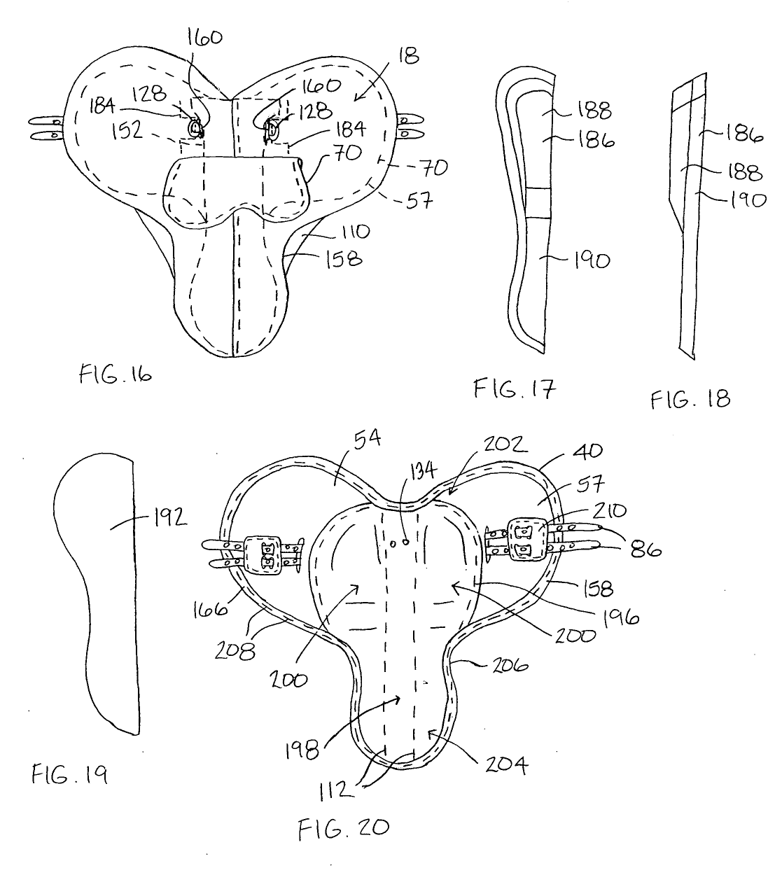

FIGS. 17 and 18 show a top view and a side view, respectively, of a right side sculpted back pad 186. The right side back pad will be secured to a right side of saddle body 57. Similarly, a mirror image left side back pad (not shown) will be secured to a left side of saddle body 57. Back pad 186 may be manufactured of first 188 and second 190 pieces of half inch thick white XPE foam glued together.

FIG. 19 shows a top view of a right side back pad foam 192 which may be manufactured of one quarter inch thick MLC foam.

FIG. 20 shows a bottom view of treeless saddle 40 wherein left and right sculpted back pads 186 (see FIG. 17) are glued to underside 54 of saddle body 57 and left and right back pad foam pieces 192 are glued to back pads 186 in back contacting regions 200. Prior to gluing of back pads 186 and back pad foam pieces 192 to saddle body 57, the unsewn portions of gullet cover 110 are pulled to one side such that each back pad 186 and back pad foam 192 is glued to its corresponding left or right side portion of saddle body 57 underneath gullet cover 110. After gluing of the pads to saddle body 57, gullet cover 110 is stretched over back pads 186 and back pad foam pieces 192, and is glued and sewn in place on saddle body 57 by stitching 196. Stitching 196 extends completely around gullet cover 110 and also closes off the forward and reward portions of stitch lines 112. After stitching, any excess portion of gullet cover 110 may be trimmed to define a neat edge of gullet cover 110.

After the gullet cover 110 is secured in place, the bottom side 54 of saddle 40 defines recessed gullet region 198 positioned between outwardly extending back contacting regions 200. Back contacting regions 200 each extend outwardly from saddle body 57 a greater distance in a forward region 202 than in a rearward region 204. This difference in the thickness at the forward region compensates for the forces that may be applied behind the shoulder region of the horse during riding, such as when the rider is positioned upwardly in the saddle and has his feet positioned behind him or her, thereby thrusting the rider forwardly on the horse and saddle.

Still referring to FIG. 20, after the gullet cover 110 is secured in place, the edge 166 of body cover 158 is folded around the edge of saddle body 57 to an underside of saddle body 57 and then sewn with stitching 208. After stitching, any excess portion of body cover 158 may be trimmed to define a neat edge of body cover 158. After this final stitching step, the saddle 40 may be cleaned of all residual glue and the exposed edges of the leather components may be dyed or stained as desired. After such detailing and cleaning of the saddle, buckle guards 210 may be attached to billet straps 86.

Due to the manufacturing steps listed above, substantially the only material positioned between the rider and the horse is flexible leather and foam pads. This construction results in a flexible saddle providing comfort for both horse and rider and reducing the chance of injury to the horse's back or shoulders. Moreover, due to the flexible nature of the saddle, which moves in conformity with each and every movement of the horse, the treeless flexible saddle of the present invention allows a rider to instantly feel the horse's movements, and allows the horse to instantly sense the movements of the rider, thereby allowing the rider to ride in a state of complete harmony and communication with his or her horse.

The leather pieces of the saddle of the present invention typically are a classic brown leather color. However, other colors or types of leather, and other durable materials may be used for manufacture of the saddle. Moreover, the saddle of the present invention may be manufactured in any size and with modifications to the method described herewith, while still retaining the invention features of the present invention.

While preferred embodiments of the present invention have been shown and described, it will be apparent to those skilled in the art that many changes and modifications may be made without departing from the invention in its broader aspects. The appended claims are intended to cover, therefore, all such changes and modifications as fall within the true spirit and scope of the invention.

I claim:

1. A flexible, treeless saddle comprising:
a non-rigid saddle body including a top surface; and
a stirrup hanger cover secured to said top surface and positioned only in a pommel region of said body.

2. A saddle according to claim 1 wherein said stirrup hanger cover comprises a flap secured only along a rear edge thereof to said top surface of said saddle body.

3. A saddle according to claim 1 further comprising a stirrup hanger secured to said saddle body and positioned underneath said stirrup hanger cover.

4. A saddle according to claim 3 further including a seat pad that includes recessed regions aligned with said stirrup hanger.

5. A saddle according to claim 1 wherein said top surface defines a flat cantle region.

6. A saddle according to claim 1 wherein said saddle body includes a leg region and wherein said bottom surface of said leg region is adapted for direct contact with a horse and said top surface of said leg region is adapted for direct contact with a rider's leg.

7. A saddle according to claim 1 further comprising a billet strap at least partially visibly exposed on a lower, horse contacting surface of said saddle body.

8. A saddle according to claim 1 further comprising a non-rigid back contacting pad secured to a lower surface of said saddle body, said back contacting pad defining a recessed gullet region extending along a central region of said saddle body.

9. A frameless, flexible saddle comprising:
a bendable saddle body including an underside and a topside that defines a flat seat region; and
a billet strap secured to said saddle body and at least partially visibly exposed on said underside.

10. A saddle according to claim 9 further comprising a stirrup hanger cover secured to said topside rearwardly of said billet strap.

11. A saddle according to claim 10 wherein said stirrup hanger cover includes a rear edge sewn to said topside and a forward edge unsecured to said topside.

12. A saddle according to claim 9 wherein said seat region defines a flat cantle region and wherein said underside defines a recessed gullet region.

13. A saddle according to claim 9 further comprising a pommel raised upwardly from said seat region.

14. A flexible, treeless saddle comprising:
a non-rigid saddle body manufactured of flexible material and having a top surface that defines a seat region;
a non-rigid pommel manufactured of flexible material and extending upwardly from said seat region; and
a stirrup hanger at least partially visibly exposed on said top surface.

15. A saddle according to claim 14 further comprising a stirrup hanger cover secured to said top surface and extending only throughout a pommel region of said body, said stirrup hanger cover nominally covering said stirrup hanger.

16. A saddle according to claim 14 wherein said body defines a bottom surface, and wherein said bottom surface and said top surface are secured to one another in an edge region of said body.

17. A saddle according to claim 16 further comprising a billet strap at least partially visibly exposed on said bottom surface.

18. A saddle according to claim 14 wherein said body includes a bottom surface that includes a recessed gullet region.

19. A flexible, treeless saddle comprising:
a non-rigid saddle body manufactured of flexible material and having a top surface that defines a seat region and a non-rigid back contacting surface that defines a recessed gullet region extending along a central region of said saddle body; and
wherein said back contacting surface and said top surface are secured to one another in an edge region of said body.

20. A saddle according to claim 19 further comprising a billet strap and a stirrup hanger each secured to said body between said top surface and said back contacting surface, and wherein at least a portion of said billet strap is visibly exposed on said bottom surface and wherein at least a portion of said stirrup hanger is visibly exposed on said top surface.
